(19) United States
(12) Patent Application Publication
(10) Pub. No.: US 2016/0210805 A1
(43) Pub. Date: Jul. 21, 2016

(54) METHOD OF HANDLING CASH IN RETAIL SHOP AND SYSTEM ADOPTING THE METHOD

(71) Applicant: MFS Corporation, Seoul (KR)

(72) Inventor: Dong Gyun Kim, Seoul (KR)

(73) Assignee: MFS Corporation, Seoul (KR)

(21) Appl. No.: 14/992,836

(22) Filed: Jan. 11, 2016

(30) Foreign Application Priority Data
Jan. 16, 2015 (KR) 10-2015-0008253

(51) Int. Cl. G07D 11/00; G06K 7/10

(52) U.S. Cl. CPC G07D 11/0021; G06K 7/10009

(57) ABSTRACT

A cash handling method includes: interworking or linking data regarding cash deposit into or withdrawal from a front-end machine (FEM), provided in a retail shop, with a banking system; providing an electronic tag to a filling cassette (FC), comprised in the FEM and configured to store cash, and providing a unique identification number to the electronic tag with respect to the FCs; and when the FCs are filled with a certain amount of cash or fully, transporting the FCs to a bank having the banking system, and depositing the cash in the FCs having the unique identification number into the bank.

### CROSS-REFERENCE TO RELATED APPLICATION

This application claims the benefit of Korean Patent Application No. 10-2015-0008253, filed on Jan. 16, 2015, in the Korean Intellectual Property Office, the disclosure of which is incorporated herein in its entirety by reference.

### BACKGROUND

1. Field

One or more exemplary embodiments relate to a cash handling system used for a shop in which products are transacted, and more particularly, to a cash handling system for interworking cash deposit or withdrawal, processed by a cashier, with a banking system.

2. Description of the Related Art

Generally, most transactions of cash in a retail shop are performed via a point-on-sailing (POS) system, and cash obtained from the transactions is deposited into a bank by using a general transportation vehicle. A transportation vehicle such as a cash-in-transit vehicle is used to transport cash collected from the retail shop to the bank. In such a cash deposit, withdrawal, and transportation system in the related art, an amount or a location of cash may not be actually tracked.

In detail, cash is managed in a retail shop as follows:
1) Cash is withdrawn directly from a bank, and transported to the retail shop.
2) When the cash transmitted from the bank arrives at a back room in the retail shop, a retail shop personnel settles an account of the cash and stores the cash.
3) A cashier needs to manually divides (classify) the cash according to cash types or unit, and put the cash into a POS safe in each front-end machine,
4) Customers, who have purchased a product, pay cash directly to the cashier and get a change.
5) When the retail shop closes for a day or the cashier shifts with another cashier, the cashier settles cash, and then, moves the cash to the back room.
6) A manager finishes settlement of the cash, and prepares for deposit of the cash into the bank for a next day.
7) A cash-in-transit (CIT) company transports the cash to deposit the cash into the bank.

In a retail shop in the related art, a cashier has received notes and coins from a customer and stored the notes and the coins in a POS safe. If the POS safe is filled with the notes and the coins, or if the cashier shifts with another cashier, the cashier moves the notes and the coins from the POS safe to a back room for cash settlement, checks an actual sum of the cash, and transports the cash to a bank or the like, by using a CIT company. Such a method in the related art may take time and cost to settle and transport the cash, or loss of the cash may occur.

### SUMMARY

One or more exemplary embodiments include a method of handling cash in a retail shop connected to a real-time banking system, and a system adopting the cash handling method.

Accordingly, one or more exemplary embodiments include a method of handling cash in a retail shop by linking or interworking a process of handling cash at locations ranging from a front-end machine (FEM) to a bank, and a system adopting the method.

Additional aspects will be set forth in part in the description which follows and, in part, will be apparent from the description, or may be learned by practice of the presented embodiments.

According to one or more exemplary embodiments, a cash handling method includes: interworking or linking data regarding cash deposit into or withdrawal from a front-end machine (FEM), provided in a retail shop, with a banking system; providing an electronic tag to a filling cassette (FC), included in the FEM and configured to store cash, and providing a unique identification number to the electronic tag with respect to the FCs; and if the FCs are filled with a certain amount of cash, transporting the FCs to a bank having the banking system, and depositing the cash in the FCs having the unique identification number into the bank.

The FEM may be under control by the banking system, and data regarding cash deposit into or withdrawal from the FCs in the FEM, which have the unique identification number, may be processed and stored by the banking system.

The cash handling method may further include: transporting the FCs from the FEM to a back room having a back-end machine (BEM); and transporting the FCs from the back room to the bank.

The cash deposit into or withdrawal from a front-end machine (FEM) and the transporting of the FC may interwork with the banking system, and the bank using the banking system may have a right to manage or control the data regarding the cash deposit or withdrawal.

The cash deposit into or withdrawal from an FEM and the transporting of the FC may interwork with the banking system, and the bank using the banking system may have a right to manage or control the data regarding the cash deposit or withdrawal.

The cash deposit into or withdrawal from an FEM and the transporting of the FC may interwork with the banking system, and the bank using the banking system may have a right to manage or control the data regarding the cash deposit or withdrawal.

The electronic tag may employ a radio-frequency identification (RFID) method, and the FEM and the banking system in the bank may include a tag recognition system employing the RFID method.

According to one or more exemplary embodiments, a cash handling system adopting the cash handling method includes: one or more front-end machines provided in a retail shop in which cash is deposited or withdrawn; filling cassettes (FCs) configured to store cash so as to deposit or withdraw the cash; electronic tags provided in the FCs, and including a unique identification number of the FCs; a banking system connected to the FEM, and configured to monitor the deposit or the withdraw of the cash with respect to the FEM and store a result of the monitoring; and a transportation system configured to transport the FCs to a bank having the banking system.

The cash handling system may further include: a back room including a back-end machine configured to store or perform an intermediary process on the FCs transported from the FEM.

The FEM may be under control by the banking system, and data regarding cash deposit into or withdrawal from the FCs in the FEM, which have the unique identification number, may be processed and stored by the banking system.

The FCs from the FEM may be transported to a back room having a back-end machine (BEM); and the FCs from the back room may be transported to the bank.

The electronic tag may be a radio-frequency identification (RFID) tag, and the FEM and the banking system in the bank may include a recognition system for the RFID tag.

### BRIEF DESCRIPTION OF THE DRAWINGS

These and/or other aspects will become apparent and more readily appreciated from the following description of the embodiments, taken in conjunction with the accompanying drawings in which:

FIG. 1 is a flowchart of a cash handling method, according to an exemplary embodiment;

FIG. 2 is a flowchart of a cash handling method, according to another exemplary embodiment;

FIG. 3 illustrates a schematic configuration diagram showing a cash handling system, according to an exemplary embodiment; and

FIG. 4 is a schematic configuration diagram of a filling cassette (FC) used in the cash handling system, according to an exemplary embodiment; and

FIG. 5 is a block diagram showing a structure of the cash handling system in which a front-end machine (FEM) in a retail shop is connected to a banking system, according to an exemplary embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the exemplary embodiments are merely described below, by referring to the figures, to explain aspects of the present description.

Hereinafter, a cash handling method and a system adopting the method are will be described in detail with reference to the accompanying drawings, in which exemplary embodiments are shown.

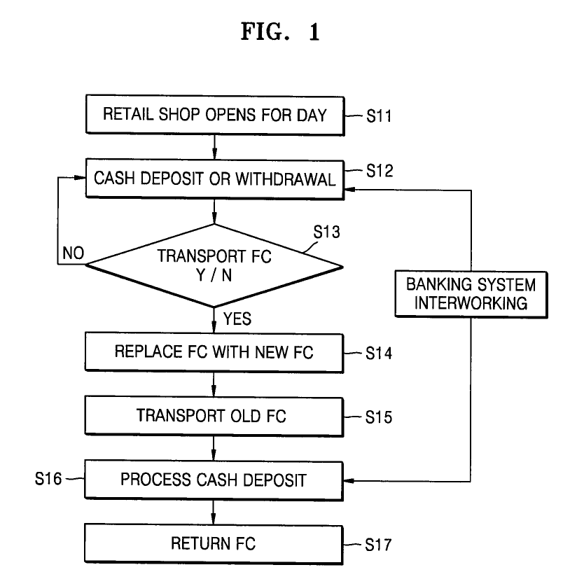

FIG. 1 is a flowchart of a cash handling method according to an exemplary embodiment.

While a retail shop opens for a day in operation S11, cash is deposited into a front-end machine (FEM) or a change is withdrawn from the front-end machine?) according to product sales in operation S12.

The retail shop is provided with an FEM, and the FEM includes a filing cassette (FC) in which the cash is stored. The FEM having the FC is connected to a banking system in a bank, and operates like an automated teller machine (ATM) directly connected to the banking system in the bank. Thus, cash deposit or withdrawal is transmitted to, and thus, reflected in the banking system.

While cash deposit or withdrawal is processed by the FEM In the state described above, it is determined whether the retail shop has closed for the day or whether the FC that is currently being used is completely filled with cash, and thus, needs to be replaced with new FC and the used FC should be transferred to a bank or a back room, in operation S13. As a result of the determining, if it is determined that the FC needs to be separated from the FEM or replaced by a new one, use of the FEM is stopped, and then, the FC that needs to be replaced (an old FC) is replaced by a new FC.

A unique electronic tag, for example, a radio-frequency identification (RFID) tag may be attached to the FC. The attachment of the unique electronic tag is to monitor and control a location of the FC, and the FC is identified by an FEM, a back room, a banking system via the electronic tag such as the RFID tag.

After a new cassette box is installed in the FEM, while product sales using the FEM are consistently performed, the old FC replaced, and thus, separated from the FEM is transported to the bank in operation S15. In operation S16, the bank receives the old FC, and processes the deposit of the cash. The FC from which the cash is removed is returned to the retail shop in operation S17.

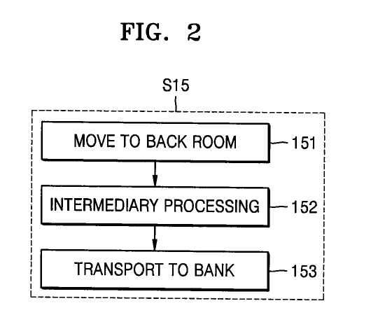

FIG. 2 shows an embodiment of the transporting of the FC to the bank.

FCs separated from the FEM may be immediately transported to a bank, and cash deposit may be processed. However, as shown in FIG. 2, before the FCs are transported to the bank, the FCs may be transferred to a place, for example, a back room in which an intermediary processing is to be performed on an FC transmitted from a retail shop, in operation S151. Then, the FC is simply stored without having to receive any processing, or an intermediary processing, such as checking of a state of the FC or objects included in the FC, is performed on the FC in operation S152. Then, several FCs may be transported at a same time to the bank in operation S153.

By using the method described above, the FC is transported from the FEM in the retail shop to the bank. Additionally, the FEM is connected to a banking system in the bank so that deposit and withdrawal of cash in the retail shop are reflected in the banking system in real time. In this case, before until cash is actually deposited into the banking system, deposit and withdrawal of the cash are recorded in the banking system according to time sequence via a separate temporary banking account. Then, after cash is deposited into the temporary banking account last, that is, the depositing of the cash into the temporary banking account is finished, the cash deposit and withdrawal may be reflected in a main banking account.

As described above, in this process, a location of the FC may be checked in real time by using an RFID tag located on the FC.

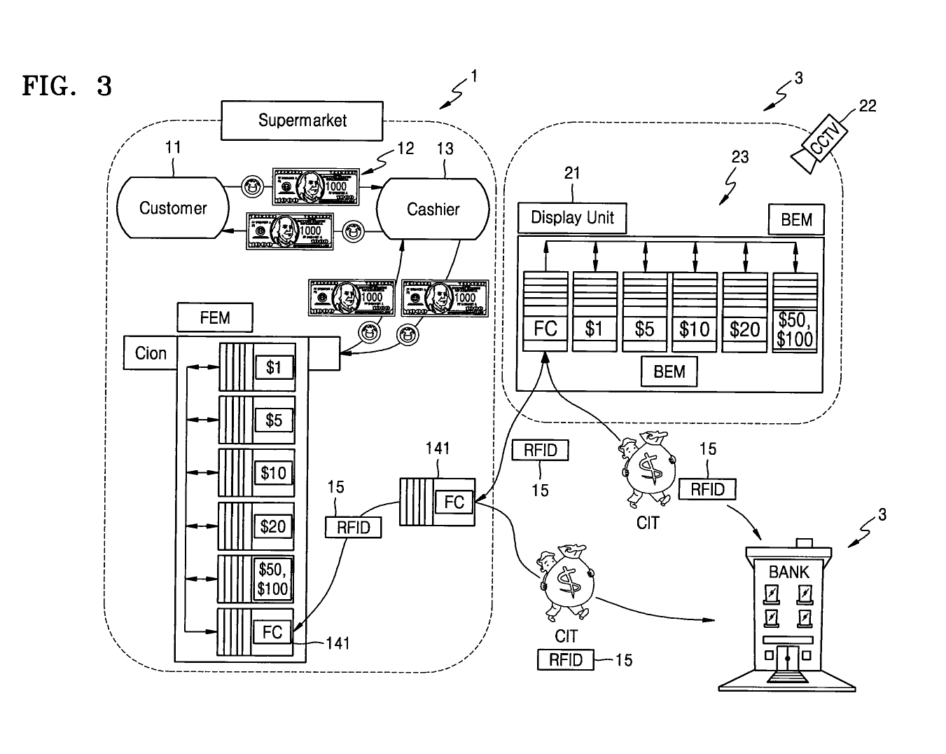

FIG. 3 illustrates a schematic configuration diagram showing a cash handling system adopted to the cash handling method, according to an exemplary embodiment.

Cash 12 such as a product cost and change is exchanged between a customer 11, having collected products, and a cashier 13 in a retail shop 1 such as a supermarket, or the like.

The cashier 13 deposits cash and withdraws change via a cash deposit and withdrawal module included in an FEM 14. The FEM 14 includes a plurality of FCs 141 that are classified by cash types.

Notes and coins, input to the FEM 14 by the cashier 13, are automatically classified into and moved to the plurality of FCs 141 according to the cash types. As described above, input (deposit) of cash and withdrawal of cash are recorded to a particular account in a banking system. In other words, a product cost, input to the FEM 14, is deposited to a banking account of a retail shop, such as a small shop or a supermarket, via an automated teller machine (ATM) network (a banking network). Accordingly, since data regarding cash deposit into or withdrawal from the FEM 14 is managed by the banking system, the bank may have a property right and a management right to the data regarding the cash deposit or withdrawal. In other words, the FEM 14 may be an expanded apparatus of the ATM.

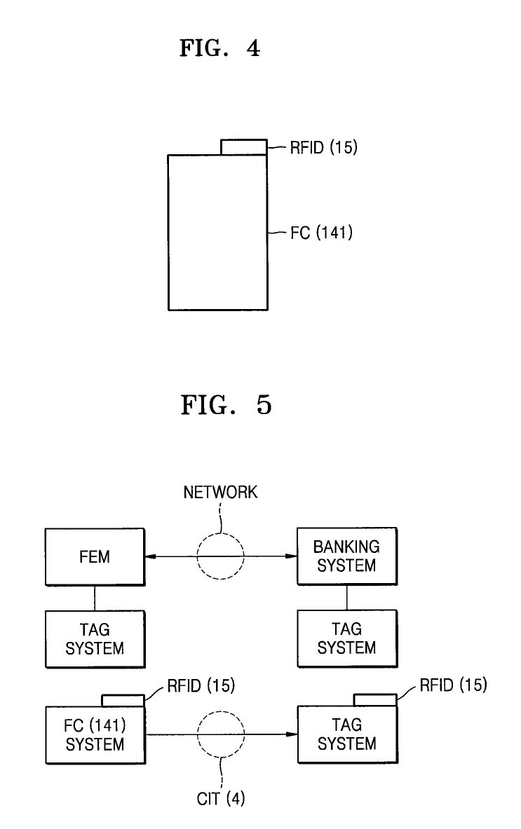

Notes are charged via the plurality of FCs 141 in the FEM 14 according to each note type. If the plurality of FCs 141 are filled with each type of note, the plurality of FCs 141 are replaced by a new one, and transmitted to a bank 3 directly or via a back room 2. If a back room is not present in the retail shop, the FEM 14 may not pass through the back room 2, and may be directly transported to the bank 3. As shown in FIG. 4, all of the plurality of the FCs 141 have an RFID tag 15 having a symbol such as a unique serial number. The RFID tag 15 is provided to identify an FC 141.

The plurality of FCs 141 are separated from the FEM 14, and then, transported to the bank 3 directly or via the back room 2. A back-end machine 23 for accommodating the plurality of FCs 14, a display unit 21 for displaying information regarding settlement of cash deposit and withdrawal, and a closed-circuit television (CCTV) 22 for monitoring an inside of the back room 2 may be included in the back room 2. The plurality of FCs 141 may be transported to the bank 3 by a cash-in-transit (CIT) company 4 that is managed by the bank or the banking system. As shown in FIG. 5, unique symbols of the plurality of FCs 141 are recognized by a tag system via an electronic tag such as an RFID tag, and managed by the banking system. The FEM 14 and the banking system are connected to each other via a network such as the Internet, and may share data with each other in real time.

The CIT company 4 transports empty box FCs from the bank 3 to the retail shop, so that the FEM 14 and the BEM 22 operate smoothly.

According to the method and the apparatus (system) described above, advantages that may obtained are as follows:
1) As an FEM and a banking system work together, a revenue at a retail shop may be monitored in real time, and deposit of cash at the retail shop may be processed as deposit of the case into a bank.
2) A cashier's mistake or theft of cash may be prevented in advance.
3) Cash may be protected from a crime safely.
4) Personnel and management costs may be reduced by reducing labor force.
5) Shop opening hours and a shop operating cost may be reduced by simplifying an operation system.
6) An error and inconvenience to a customer, which may occur in an unmanned system, may be prevented.

According to exemplary embodiments, since a retail shop may be connected to a banking system in real time with respect to cash deposit and withdrawal, it may be easy to deposit or withdraw cash. Additionally, since cash deposit or withdrawal may be input to a banking account in real time by using an FEM. In other words, according to exemplary embodiments, work between the retail shop and the bank may be facilitated and smoothly performed by operating an FEM in the retail shop like an ATM present in a banking system.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A cash handling method comprising:
interworking or linking data regarding cash deposit into or withdrawal from a front-end machine (FEM), provided in a retail shop, with a banking system;
providing an electronic tag to a filling cassette (FC), comprised in the FEM and configured to store cash, and providing a unique identification number to the electronic tag with respect to the FCs; and
if the FCs are filled with a certain amount of cash, transporting the FCs to a bank having the banking system, and depositing the cash in the FCs having the unique identification number into the bank.

2. The cash handling method of claim 1, wherein the FEM is under control by the banking system, and data regarding cash deposit into or withdrawal from the FCs in the FEM, which have the unique identification number, is processed and stored by the banking system.

3. The cash handling method of claim 1, further comprising:
transporting the FCs from the FEM to a back room having a back-end machine (BEM); and transporting the FCs from the back room to the bank.

4. The cash handling method of claim 1, wherein the cash deposit into or withdrawal from a front-end machine (FEM) and the transporting of the FC interwork with the banking system, and the bank using the banking system has a right to manage or control the data regarding the cash deposit or withdrawal.

5. The cash handling method of claim 2, wherein the cash deposit into or withdrawal from an FEM and the transporting of the FC interwork with the banking system, and the bank using the banking system has a right to manage or control the data regarding the cash deposit or withdrawal.

6. The cash handling method of claim 3, wherein the cash deposit into or withdrawal from a front-end machine (FEM) and the transporting of the FC interwork with the banking system, and the bank using the banking system has a right to manage or control the data regarding the cash deposit or withdrawal.

7. The cash handling method of claim 1, wherein the electronic tag employs a radio-frequency identification (RFID) method, and the FEM and the banking system in the bank comprise a tag recognition system employing the RFID method.

8. A cash handling system adopting the cash handling method of claims 1, the cash handling system comprising:
one or more front-end machines provided in a retail shop in which cash is deposited or withdrawn;
filling cassettes (FCs) configured to store cash so as to deposit or withdraw the cash;
electronic tags provided in the FCs, and comprising a unique identification number of the FCs;
a banking system connected to the FEM, and configured to monitor the deposit or the withdraw of the cash with respect to the FEM and store a result of the monitoring; and
a transportation system configured to transport the FCs to a bank having the banking system.

9. The cash handling system of claim 8, further comprising a back room comprising a back-end machine configured to store or perform an intermediary process on the FCs transported from the FEM.

10. The cash handling system of claim 8, wherein the FEM is under control by the banking system, and data regarding cash deposit into or withdrawal from the FCs in the FEM, which have the unique identification number, is processed and stored by the banking system.

11. The cash handling system of claim 8, wherein the FCs from the FEM is transported to a back room having a back-end machine (BEM); and the FCs from the back room is transported to the bank.

12. The cash handling system of claim 8, wherein the electronic tag is a radio-frequency identification (RFID) tag, and the FEM and the banking system in the bank comprise a recognition system for the RFID tag.
